(19) United States
(12) Patent Application Publication
(10) Pub. No.: US 2024/0364378 A1
(43) Pub. Date: Oct. 31, 2024

(54) Cell Phone Belt Device

(71) Applicant: Brian German, Muskegon, MI (US)

(72) Inventor: Brian German, Muskegon, MI (US)

(21) Appl. No.: 18/641,688

(22) Filed: Apr. 22, 2024

Related U.S. Application Data
(60) Provisional application No. 63/461,929, filed on Apr. 26, 2023.

(51) Int. Cl. H04B 1/3888; A45C 13/30; H04B 1/3827; H04M 1/04

(52) U.S. Cl. CPC H04B 1/3888; A45C 13/30; H04B 1/385; H04M 1/04; H04B 2001/3855

(57) ABSTRACT

A cell phone belt device is disclosed for preventing theft and damage of property. The cell phone belt device comprises a body component that is configured in a rectangular pouch for retaining a cell phone or other item. The body component is secured to a strap component. The strap component is a heavy-duty strap with a buckle for loosening or tightening the strap and for securing the cell phone in place. The buckle is adjustable for comfort. The cell phone belt device is available in different colors and styles.

### CROSS-REFERENCE TO RELATED APPLICATION

The present application claims priority to, and the benefit of, U.S. Provisional Application No. 63/461,929, which was filed on Apr. 26, 2023, and is incorporated herein by reference in its entirety.

### FIELD OF THE INVENTION

The present invention relates generally to the field of cell phone belt devices. More specifically, the present invention relates to an improved strap for preventing cell phones and other items from being lost or stolen. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in cell phone belt devices. Generally, people may have trouble keeping their phone secure while traveling. Additionally, a cell phone can get lost or damaged, forcing people to purchase an expensive replacement. Further, carrying a cell phone in a pants or jacket pocket can be frustrating due to its weight.

Generally, cell phones have become a very commonplace articles for a person to carry during the course of the day. Because of the small handheld nature of cell phones, cell phones are able to fit in pockets or the like, but often times it is inconvenient when a cell phone has to be placed in a pocket which is inaccessible or a purse or other bag. Therefore, there is a need for a cell phone case which prevents damage to cell phones and keeps the cell phones nearby for use.

Accordingly, there is a demand for an improved cell phone belt device that allows users to wear the device and keep their cell phone secure while traveling. More particularly, there is a demand for a cell phone belt device that prevents users from accidentally dropping or losing their cell phone.

Therefore, there exists a long felt need in the art for a cell phone belt device that provides users with an improved strap for preventing cell phones and other items from being lost or stolen. There is also a long felt need in the art for a cell phone belt device that functions like a belt, featuring a buckle for loosening or tightening the strap around an item. Further, there is a long felt need in the art for a cell phone belt device that allows users to wear the device and keep their cell phone or other personal items secure while traveling. Moreover, there is a long felt need in the art for a device that prevents users from accidentally dropping or losing a cell phone. Further, there is a long felt need in the art for a cell phone belt device that saves considerable money on repairs and replacement cell phones. Finally, there is a long felt need in the art for a cell phone belt device that is available in different colors and styles.

The subject matter disclosed and claimed herein, in one embodiment thereof, comprises a cell phone belt device. The device is a new strap device for preventing theft and damage of property. The cell phone belt device comprises a body component that is configured in a rectangular pouch for retaining a cell phone or other item. The body component is secured to a strap component. The strap component is a heavy-duty strap with a buckle for loosening or tightening the strap and that can be used to keep an object closed or tied down. The buckle is adjustable for comfort. The cell phone belt device is available in different colors and styles.

In this manner, the cell phone belt device of the present invention accomplishes all of the forgoing objectives and provides users with a device that functions like a belt and allows users to wear their cell phones safely. The device is a pouch for the cell phone secured to a strap and buckle. The device can be available in different sizes and styles.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone belt device for preventing theft and damage of property. The cell phone belt device comprises a body component that is configured in a rectangular pocket for retaining a cell phone or other item. The body component is secured to a strap component during use. The strap component is a heavy-duty strap with a buckle for loosening or tightening the strap and for securing the cell phone in place. The buckle is adjustable for comfort.

In one embodiment, the cell phone belt device of the prevent invention helps a user safely and securely transport their cell phone or other electronic device. The desire to have a telephone on hand at all times has created the booming market of cellular communications. Today, people are using Cellular and digital telephones for multitasking activities such as getting stock quotes, e-mailing friends and colleagues, transmitting computer files, checking traffic and weather reports, “surfing” the Internet, and making phone calls while on-the-go. Compact in size, most cellular phones can fit in a briefcase, purse or pocket with ease. The popularity of cell phones has enjoyed phenomenal growth in recent years. Further, the benefits of owning a cellular phone have never been disputed.

Although there is little doubt that cellular telephones are extremely useful devices, they do little good if not easily accessible. Accordingly, missing an important call simply because one's phone cannot be effortlessly located can be extremely frustrating. In addition, the problem of dropping and breaking one's cellular phone during use is an extreme challenge to many cellular subscribers. Furthermore, many consumers store their cellular telephones in pants or shirt pockets, or in the pouches of backpacks, briefcases and purses, which can be somewhat unsafe. Unfortunately, the simple act of bending over to tie a shoe can result in the cell phone falling out and crashing to the ground, possibly damaging the cell phone. Accordingly, the present invention was developed based on recognizing the need for a device that would provide ready access to one's cellular equipment, while effectively preventing a cellular telephone from falling and breaking when stored.

In one embodiment, the cell phone belt device is a specially designed belt featuring an integrated storage pocket for use with cellular telephones, and other electronic devices. Thus, providing convenient and secure access for these much needed cellular accessories. The invention provides users with a comfortable and safe means for storing and transporting their cellular phones.

In one embodiment, the cell phone belt device comprises a strap component which is configured in the shape of a conventional belt. The strap component comprises a buckle or other securing means attached at one end. The strap component is a lightweight and comfortable waist belt manufactured primarily of heavy-duty material. In addition, higher end versions of the strap component are also available and can be manufactured of canvas, nylon or even leather or suede material. If the user desires, the strap component can be adorned with any number of decorative embellishments including rhinestones, beads, fringe or embroidery, to name a few options. Further, the strap component can be produced in a myriad of stylish colors and designs, as well as more subdued neutral hues. Further, the strap component is produced in a range of sizes for wear by male and female users and can be held comfortably about the waist by means of the adjustable buckle fastener or other securing means as is known in the art.

In one embodiment, the strap component comprises a body component secured to it. The body component is sized and shaped to retain a cell phone or other electronic device. Typically, the body component is manufactured of molded and shatterproof plastic or rubber material or can be manufactured of the same material as the strap component itself and is securely attached to the surface of the strap component in an easily accessed location, such as on the hip. Generally, the body component is rectangular in shape and sized appropriately to accommodate the various makes and models of cellular telephones available on the market. Accordingly, this body component measures approximately five to seven inches in height by two to four inches in width, with a depth of approximately one to two inches. Further, the body component comprises a pocket portion with an open cavity for retaining the cell phone and in one embodiment a flap portion for enclosing the pocket portion and securing the cell phone inside. The pocket portion comprises a forward wall, a pair of side walls, and a rear wall secured together to form an interior cavity for retaining the cell phone in a substantially vertical position.

In one embodiment, the pocket portion of the body component also comprises integrated storage pockets or pouches for use in storing credit cards, drivers licenses, and identification cards, cash or other personal items inside.

In one embodiment, the pocket portion of the body component can be an open configuration with no covering. In another embodiment, the body component comprises a flap covering, which secures the open top of the body component. The flap covering comprises snaps, clasps, Velcro, buckles, clasps, adhesives, or magnetic fasteners to secure the flap covering in place over the interior cavity, which secures the cell phone within the body component. Once the cell phone is positioned within the interior cavity, the flap covering is brought to the down position to cover the interior cavity opening and secure the cell phone within the cavity. In yet another embodiment, the top of the body component comprises a zipper to enclose the cell phone within the body component. Thus, once positioned in the body component, the cellular telephone is easily accessed, yet safely secured in the cell phone belt device at all times.

In one embodiment, the body component is secured to the strap component via any suitable securing means as is known in the art, such as adhesives, snaps, fasteners, Velcro, etc., depending on the needs and/or wants of a user. Typically, the body component is releasably secured to the strap component, such that the strap component can be threaded through a user's belt loops of their pants or other clothes, and then once the strap component is in place, the body component can be secured to the strap component. Typically, the rear wall of the body component comprises the securing means which releasably secures to an exterior surface of the strap component.

In another embodiment, the body component comprises an elongated opening or slit along its rear wall, wherein a portion of the strap component would extend through the elongated opening, similar to a belt loop, so that when the body component is in place on the strap component, the body component is engaged between the strap component and the user's pants, supporting the body component in place. Thus, in position, the strap component has been threaded through the elongated opening, so that the body component is held against the user's clothes by the strap component being engaged through the elongated opening.

In use, the user purchases the cell phone belt device in the desired size, donning the strap component as they would any other waist belt. With the cell phone belt device properly secured about the waist by means of the adjustable buckle fastener, the user then places their cell phone within the device's body component, securing the body component closed by means of its integrated flap covering with snaps, zippers, buckles, Velcro, etc. Now that the cell phone is safely encased within the cell phone belt device, the cell phone can be easily retrieved whenever needed, with the user simply removing their cell phone from the strap component and returning it following use. After use, the cell phone belt device is removed and stored away until needed again.

In yet another embodiment, the cell phone belt device comprises a plurality of indicia.

In yet another embodiment, a method of securely and safely transporting a cell phone when traveling is disclosed. The method includes the steps of providing a cell phone belt device comprising a body component secured to a strap component with a buckle. The method also comprises securing the strap component around a user's waist and securing the strap component with the buckle. Further, the method comprises inserting a cell phone into the body component and securing it in place. Finally, the method comprises traveling while transporting the cell phone within the body component without worry of losing or breaking the cell phone.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cell phone belt device of the present invention showing the body component secured to the strap component in accordance with the disclosed architecture;

FIG. 2 illustrates a perspective view of one embodiment of the cell phone belt device of the present invention showing the body component as an open pocket in accordance with the disclosed architecture;

FIG. 3 illustrates a perspective view of one embodiment of the cell phone belt device of the present invention showing the body component as a pocket with a flap that snaps closed in accordance with the disclosed architecture;

FIG. 4 illustrates a perspective view of one embodiment of the cell phone belt device of the present invention showing the body component as a pocket with a zipper closure in accordance with the disclosed architecture;

FIG. 5 illustrates a perspective view of one embodiment of the cell phone belt device of the present invention in use in accordance with the disclosed architecture; and

FIG. 6 illustrates a flowchart showing the method of securely and safely transporting a cell phone when traveling in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cell phone belt device that provides users with an improved strap for preventing cell phones and other items from being lost or stolen. There is also a long felt need in the art for a cell phone belt device that functions like a belt, featuring a buckle for loosening or tightening the strap around an item. Further, there is a long felt need in the art for a cell phone belt device that allows users to wear the device and keep their cell phone or other personal items secure while traveling. Moreover, there is a long felt need in the art for a device that prevents users from accidentally dropping or losing a cell phone. Further, there is a long felt need in the art for a cell phone belt device that saves considerable money on repairs and replacement cell phones. Finally, there is a long felt need in the art for a cell phone belt device that is available in different colors and styles.

The present invention, in one exemplary embodiment, is a novel cell phone belt device for preventing theft and damage of property. The cell phone belt device comprises a body component that is configured in a rectangular pouch for retaining a cell phone or other item. The body component is secured to a strap component. The strap component is a heavy-duty strap with a buckle for loosening or tightening the strap and for securing the cell phone in place. The buckle is adjustable for comfort. The cell phone belt device is available in different colors and styles. The present invention also includes a novel method of securely and safely transporting a cell phone when traveling. The method includes the steps of providing a cell phone belt device comprising a body component secured to a strap component with a buckle. The method also comprises securing the strap component around a user's waist and securing the strap component with the buckle. Further, the method comprises inserting a cell phone into the body component and securing it in place. Finally, the method comprises traveling while transporting the cell phone within the body component without worry of losing or breaking the cell phone.

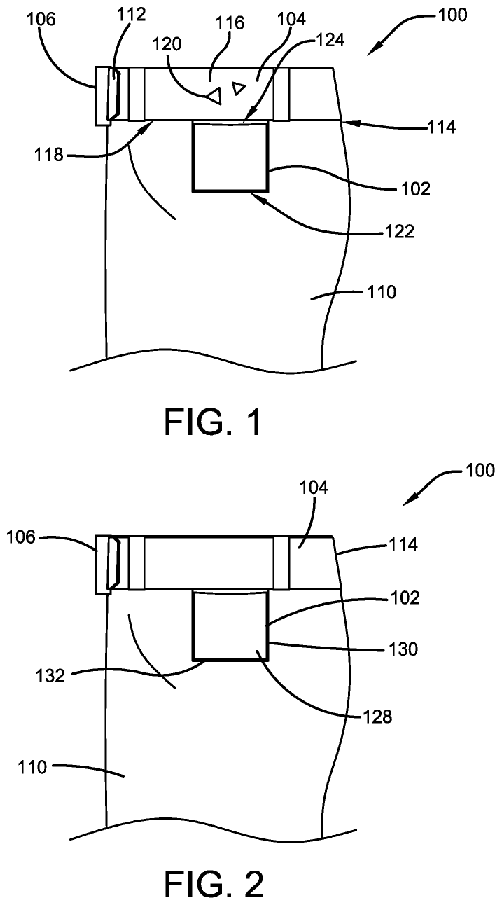

Referring initially to the drawings, FIG. 1 illustrates a perspective view of one embodiment of the cell phone belt device 100 of the present invention. In the present embodiment, the cell phone belt device 100 is an improved cell phone belt device 100 that provides a user 110 with a means for safely and securely transporting a cell phone 108. Specifically, the cell phone belt device 100 comprises a body component 102 secured to a strap component 104 during use. The strap component 104 is a heavy-duty strap with a buckle 106 for loosening or tightening the strap component 104 and for securing the cell phone 108 in place. The buckle 106 is adjustable for comfort.

Generally, the cell phone belt device 100 is a specially designed belt featuring an integrated storage pocket for use with cellular telephones 108, and other electronic devices. Thus, providing convenient and secure access for these much needed cellular accessories. The invention provides users 110 with a comfortable and safe means for storing and transporting their cellular phones 108, and other personal items, as needed.

Further, the cell phone belt device 100 comprises a strap component 104 which is configured in the shape of a conventional belt with an exterior surface 116 and an interior surface 118, as well as opposing ends 112. The strap component 104 comprises a buckle 106 or other securing means attached at one end 112, which secures the strap component 104 to a user's waist 114. The strap component 104 is a lightweight and comfortable waist belt manufactured primarily of heavy-duty material. In addition, higher end versions of the strap component 104 are also available and can be manufactured of canvas, nylon or even leather or suede material. If the user 110 desires, the strap component 104 can be adorned with any number of decorative embellishments 120 including rhinestones, beads, fringe or embroidery, to name a few options. Further, the strap component 104 can be produced in a myriad of stylish colors and designs, as well as more subdued neutral hues. For purposes of the present invention, references to ornamentation or decorative embellishments 120 refers to any and all visible characteristics of the exterior surfaces 116 of the strap component 104 discussed herein. These terms may refer to the color, texture, pattern, decoration or design of the strap component 104 exterior surface 116. Also included are physically separate elements, such as beads, stones, buttons, feathers, fur, etc., which may be attached to the strap component 104. Ornamentation includes any combination of such characteristics or elements. Further, the strap component 104 is produced in a range of sizes for wear by male and female users 110 and can be held comfortably about the waist 114 by means of the adjustable buckle fastener 106 or other securing means as is known in the art, that allows for adjustability.

Additionally, the strap component 104 comprises a body component 102 secured to it. The body component 102 is sized and shaped to retain a cell phone 108 or other electronic device. Typically, the body component 102 is manufactured of molded and shatterproof plastic or rubber material or can be manufactured of the same material as the strap component 104 itself and is securely attached to the exterior surface 116 of the strap component 104 in an easily accessed location, such as on the hip. Generally, the body component 102 is rectangular in shape and sized appropriately to accommodate the various makes and models of cellular telephones 108 available on the market. Accordingly, this body component 102 measures approximately five to seven inches in height by two to four inches in width, with a depth of approximately one to two inches. Further, the body component 102 comprises a pocket portion 122 with an open cavity 124 for retaining the cell phone 108 and in one embodiment a flap covering 126 for enclosing the pocket portion 122 and securing the cell phone 108 inside. The pocket portion 122 comprises a forward wall 128, a pair of side walls 130, and a rear wall 132 secured together to form an interior cavity 124 for retaining the cell phone 108 in a substantially vertical position.

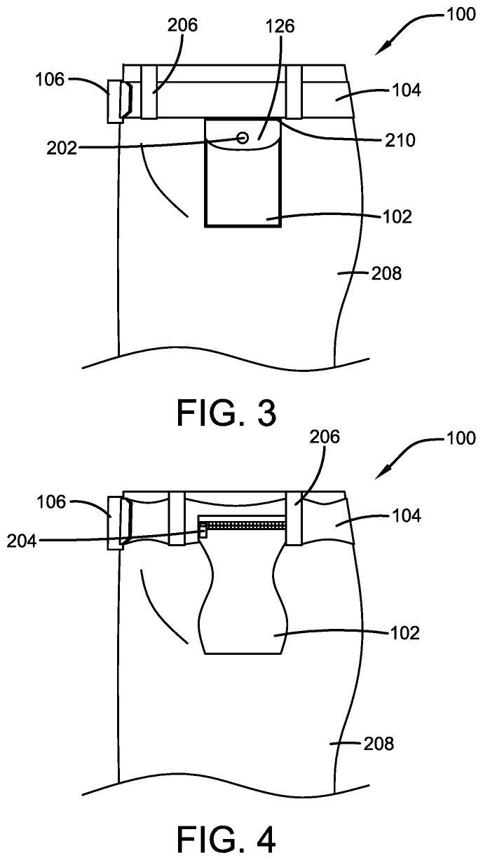

As shown in FIGS. 2-4, the pocket portion 122 of the body component 102 also comprises integrated storage pockets 200 or pouches for use in storing credit cards, drivers licenses, and identification cards, cash or other personal items inside.

In one embodiment, the pocket portion 122 of the body component 102 can be an open configuration with no covering (as shown in FIG. 2). In another embodiment, the body component 102 comprises a flap covering 126, which secures the open top 124 of the body component 102. The flap covering 126 comprises snaps 202, clasps, Velcro, buckles, clasps, adhesives, or magnetic fasteners to secure the flap covering 126 in place over the interior cavity 124, which secures the cell phone 108 within the body component 102. Once the cell phone 108 is positioned within the interior cavity 124, the flap covering 126 is brought to the down position to cover the interior cavity opening 124 and secure the cell phone 108 within the cavity 124. In yet another embodiment, the top of the body component 102 comprises a zipper 204 to enclose the cell phone 108 within the body component 102. Thus, once positioned in the body component 102, the cellular telephone 108 is easily accessed, yet safely secured in the cell phone belt device 100 at all times.

Furthermore, the body component 102 is secured to the strap component 104 via any suitable securing means 210 as is known in the art, such as adhesives, snaps, fasteners, Velcro, etc., depending on the needs and/or wants of a user 110. Typically, the body component 102 is releasably secured to the strap component 104, such that the strap component 104 can be threaded through a user's belt loops 206 of their pants or other clothes 208, and then once the strap component 104 is in place, the body component 102 can be secured to the strap component 104. Typically, the rear wall 132 of the body component 102 comprises the securing means 210 which releasably secures to an exterior surface 116 of the strap component 104.

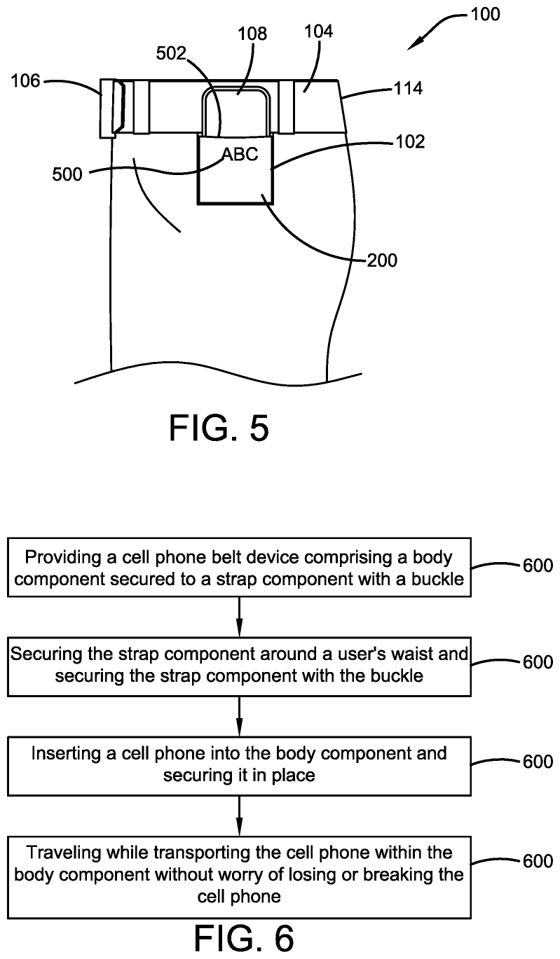

As shown in FIG. 5, the body component 102 comprises an elongated opening 502 or slit along its rear wall 132, wherein a portion of the strap component 104 would extend through the elongated opening 502, similar to a belt loop 206, so that when the body component 102 is in place on the strap component 104, the body component 102 is engaged between the strap component 104 and the user's pants 208, supporting the body component 102 in place. Thus, in position, the strap component 104 has been threaded through the elongated opening 502, so that the body component 102 is held against the user's clothes 208 by the strap component 104 being engaged through the elongated opening 502.

In use, the user 110 purchases the cell phone belt device 100 in the desired size, donning the strap component 104 as they would any other waist belt. With the cell phone belt device 100 properly secured about the waist 114 by means of the adjustable buckle fastener 106, the user 110 then places their cell phone 108 within the device's body component 102, securing the body component 102 closed by means of its integrated flap covering 126 with snaps 202, zippers 204, buckles, Velcro, etc. Now that the cell phone 108 is safely encased within the cell phone belt device 100, the cell phone 108 can be easily retrieved whenever needed, with the user 110 simply removing their cell phone 108 from the strap component 104 and returning it following use. After use, the cell phone belt device 100 is removed and stored away until needed again.

In yet another embodiment, the cell phone belt device 100 comprises a plurality of indicia 500. The body component 102 or the strap component 104 of the device 100 may include advertising, a trademark, or other letters, designs, or characters, printed, painted, stamped, or integrated into the body component 102 or the strap component 104, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be cell phone, belt, or brand related.

FIG. 6 illustrates a flowchart of the method of securely and safely transporting a cell phone when traveling. The method includes the steps of at 600, providing a cell phone belt device comprising a body component secured to a strap component with a buckle. The method also comprises at 602, securing the strap component around a user's waist and securing the strap component with the buckle. Further, the method comprises at 604, inserting a cell phone into the body component and securing it in place. Finally, the method comprises at 606, traveling while transporting the cell phone within the body component without worry of losing or breaking the cell phone.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cell phone belt device”, “cell phone device”, “belt device”, and “device” are interchangeable and refer to the cell phone belt device 100 of the present invention.

Notwithstanding the forgoing, the cell phone belt device 100 of the present invention can be of any suitable size and configuration as is known in the art without affecting the overall concept of the invention, provided that it accomplishes the above stated objectives. One of ordinary skill in the art will appreciate that the cell phone belt device 100 as shown in FIGS. 1-6 is for illustrative purposes only, and that many other sizes and shapes of the cell phone belt device 100 are well within the scope of the present disclosure. Although the dimensions of the cell phone belt device 100 are important design parameters for user convenience, the cell phone belt device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cell phone belt device that provides a user with a means for safely and securely transporting a cell phone, the cell phone belt device comprising:
a body component; and
a strap component;
wherein the body component is secured to the strap component during use;
wherein the strap component is configured as a conventional belt, secured around a user's waist; and
further wherein a cell phone is retained within the body component for transport.

2. The cell phone belt device of claim 1, wherein the strap component comprises an exterior surface and an interior surface, as well as opposing ends.

3. The cell phone belt device of claim 2, wherein the strap component comprises a buckle fastener attached at one end, which secures the strap component to a user's waist.

4. The cell phone belt device of claim 3, wherein the strap component is manufactured of canvas, nylon, leather, or suede material.

5. The cell phone belt device of claim 4, wherein the strap component comprises decorative embellishments, stylish colors, designs, or patterns, and is produced in a range of sizes for wear by male and female users and can be held comfortably about a user's waist by means of the buckle fastener.

6. The cell phone belt device of claim 5, wherein the body component is rectangular in shape and sized appropriately to accommodate various makes and models of cell phones available on market.

7. The cell phone belt device of claim 6, wherein the body component comprises a pocket portion with an open interior cavity for retaining the cell phone.

8. The cell phone belt device of claim 7, wherein the pocket portion comprises a forward wall, a pair of side walls, and a rear wall secured together to form the open interior cavity.

9. The cell phone belt device of claim 8, wherein the pocket portion of the body component comprises integrated storage pockets for use in storing credit cards, drivers licenses, and identification cards, cash or other personal items inside.

10. The cell phone belt device of claim 9, wherein the pocket portion of the body component is an open configuration with no covering.

11. The cell phone belt device of claim 9, wherein the body component comprises a flap covering with a snap, Velcro, magnetic fasteners, or adhesives, which secures the open interior cavity of the body component.

12. The cell phone belt device of claim 9, wherein a top of the body component comprises a zipper to enclose the cell phone within the body component.

13. The cell phone belt device of claim 11, wherein the body component is releasably secured to the strap component via adhesives, snaps, fasteners, or Velcro, such that the strap component is threaded through a user's belt loops of their pants and once the strap component is in place, the body component is secured to the strap component.

14. A cell phone belt device that provides a user with a means for safely and securely transporting a cell phone, the cell phone belt device comprising:
a body component comprising a pocket portion with a forward wall, a pair of side walls, and a rear wall secured together to form an open interior cavity for retaining a cell phone; and
a strap component comprising an exterior surface and an interior surface, as well as opposing ends; and
wherein the body component is releasably secured to the strap component via adhesives, snaps, fasteners, or Velcro, such that the strap component is threaded through a user's belt loops of their pants and once the strap component is in place, the body component is secured to the strap component;
wherein the strap component is configured as a conventional belt, secured around a user's waist;
wherein the strap component comprises an adjustable buckle fastener attached at one of the opposing ends, which secures the strap component to the user's waist;
wherein the body component is rectangular in shape and sized appropriately to accommodate various makes and models of cell phones available on market;
wherein a cell phone is retained within the body component for transport; and
further wherein the body component comprises a flap covering with a snap, Velcro, zipper, magnetic fasteners, or adhesives, which secures the open interior cavity of the body component.

15. The cell phone belt device of claim 14, wherein the body component comprises an elongated opening along its rear wall, wherein the strap component is threaded through, so that the body component is held against a user's clothes by the strap component.

16. The cell phone belt device of claim 14 further comprising a plurality of indicia.

17. The cell phone belt device of claim 14 wherein the pocket portion of the body component comprises integrated storage pockets for use in storing credit cards, drivers licenses, and identification cards, cash or other personal items inside.

18. The cell phone belt device of claim 14, wherein the strap component is manufactured of canvas, nylon, leather, or suede material.

19. The cell phone belt device of claim 14, wherein the strap component comprises decorative embellishments, stylish colors, designs, or patterns, and is produced in a range of sizes for wear by male and female users and can be held comfortably about a user's waist by means of the buckle fastener.

20. A method of securely and safely transporting a cell phone when traveling, the method comprising the following steps:
providing a cell phone belt device comprising a body component secured to a strap component with a buckle;
securing the strap component around a user's waist and securing the strap component with the buckle;
inserting a cell phone into the body component and securing it in place; and
traveling while transporting the cell phone within the body component without worry of losing or breaking the cell phone.
